(19) United States
(12) Patent Application Publication
(10) Pub. No.: US 2026/0334749 A1
(43) Pub. Date: Oct. 29, 2026

(54) A CLEANING DEVICE FOR VENTILATION SYSTEMS

(71) Applicant: TUNAP GMBH & CO. KG, Wolfratshausen (DE)

(72) Inventors: Michael ZARNOW, Wolfratshausen (DE); Torsten PASENAU, Lenggries (DE); Michael KEIM, München (DE); Alex LANGE, Fürholzen (DE)

(21) Appl. No.: 19/118,207

(22) PCT Filed: Oct. 5, 2023
(86) PCT No.: PCT/EP2023/077589

§ 371 Date: Apr. 3, 2025

(30) Foreign Application Priority Data
Oct. 5, 2022 (DE) 10 2022 125 655.3

(51) Int. Cl. A47L 13/16; A47L 13/26; A47L 13/44

(52) U.S. Cl. CPC A47L 13/16; A47L 13/26; A47L 13/44

(57) ABSTRACT

The present disclosure relates to a device for cleaning cavities of a ventilation system, in particular of a vehicle, by means of a cleaning agent. The device comprises a receiving portion for receiving a cleaning agent container and a cleaning portion, wherein the cleaning portion forms a support frame which is configured such that a pocket-shaped cleaning cloth can be put over the cleaning portion, so that an inner volume is formable. The cleaning portion is coupled to the receiving portion such that a cleaning agent of the cleaning agent container, which can be fastened in the receiving portion, can flow from the receiving portion into the inner volume.

This application is a national US phase of PCT/EP2023/077589 which claims the benefit of the filing date of German Patent Application No. 10 2022 125 655.3 filed 5 Oct. 2022, the disclosure of which is hereby incorporated herein by reference.

### TECHNICAL FIELD

The present disclosure relates to a device for cleaning cavities of a ventilation system, in particular of a vehicle, by means of a cleaning agent, and to a method for manufacturing the device.

### TECHNOLOGICAL BACKGROUND

Many cavities, for example in a ventilation system of a vehicle, have to be cleaned at regular time intervals, since contaminants are often deposited and the air quality is correspondingly reduced and, for example, disturbing odors are formed. For example, when a motor vehicle cabin air filter, such as, for example, a pollen air filter, is changed, an environmental cleaning of the housing, or of the so-called air filter box of the ventilation system, has to be carried out before a new filter is inserted therein. From a technical point of view, the cleaning measure when a motor vehicle cabin air filter is changed is a fundamental contribution to the overall regular hygienic maintenance of ventilation systems in motor vehicles.

The cleaning requirement for the environmental cleaning of motor vehicle cabin air filters is usually carried out by means of chemical-mechanical cleaning. A chemical cleaning liquid for dissolving and binding organic material is introduced and the mechanical removal of the contaminants takes place, for example, with the aid of a rag.

This multistage cleaning process often leads to long complex cleaning cycles, since in a first step the chemical cleaning liquid is introduced directly into the filter box by means of a spray probe and the mechanical cleaning is carried out by subsequent wiping out by means of a rag guide by hand.

Due to the optimization of air filter media, the housings of cabin air filters in motor vehicles have been considerably reduced in their height. This means that after the introduction of the chemical cleaning liquid, the contaminants can be wiped out and removed from a motor vehicle air filter box with difficulty. Neither the opening nor the spatial volume of the air filter box itself are sufficiently suitable in height for the final mechanical cleaning step by means of hand and rag.

### SUMMARY OF THE DISCLOSURE

There may be a need to simplify a cleaning process of cavities, in particular in a vehicle.

This need is met with a device for cleaning cavities and the method for manufacturing the device according to the subject matters of the independent claims.

According to a first aspect of the present disclosure, a device for cleaning cavities of a ventilation system (for example of a cabin air filter system or of an air filter box of a ventilation system), in particular of a vehicle, by means of a cleaning agent is described. The device comprises a receiving portion for receiving a cleaning agent container and a cleaning portion, wherein the cleaning portion forms a support frame which is configured such that a pocket-shaped cleaning cloth can be put over the cleaning portion, so that an inner volume (within a put-on cleaning cloth) is formable. The cleaning portion is coupled to the receiving portion such that a cleaning agent of the cleaning agent container, which can be fastened in the receiving portion, can flow from the receiving portion into the inner volume.

According to a further aspect, a method for manufacturing a device for cleaning cavities of a ventilation system, in particular of a vehicle, by means of a cleaning agent is described. The method comprises providing a receiving portion for receiving a cleaning agent container and providing a cleaning portion, wherein the cleaning portion forms a support frame which is configured such that a pocket-shaped cleaning cloth can be put over the cleaning portion, so that an inner volume is formable. Furthermore, the method comprises coupling the cleaning portion to the receiving portion such that a cleaning agent of the cleaning agent container, which can be fastened in the receiving portion, can flow from the receiving portion into the inner volume.

For an efficient ventilation and air conditioning of a vehicle, a ventilation system comprises a plurality of housings or ventilation channels with cavities, through which a desired amount of air can be conducted into predetermined regions of the vehicle. In particular, (pollen) air filters, which have to be replaced in a predetermined maintenance cycle, are provided at one or multiple locations of the ventilation system. The cavities of the ventilation system are accessible through smaller openings. Chemical cleaning agents can be introduced through these openings and mechanical cleaning elements, such as cleaning rags, can likewise be introduced.

The device according to the disclosure comprises a cleaning portion which is formed with a support frame, on which a pocket-shaped cleaning cloth can be put over, The support frame stabilizes and thus supports the cleaning cloth, so that the cleaning cloth can be introduced together with the support frame, for example, into a cavity of the ventilation system, in order to carry out a mechanical cleaning.

In particular, the support frame is formed such that a pocket-shaped cleaning cloth can be stretched, so that an interior volume (inner volume) can be formed. For example, the support frame spaces apart an opposite front and rear surface-shaped cleaning portion of the cleaning cloth. The width of the support frame, with which the cleaning cloth is stretched, is in particular less than 2 cm, in particular less than 1 cm, so that the support frame together with the cleaning cloth itself can be introduced into small ventilation openings or openings of filter boxes, through which the hand of a user would not fit. The support frame can, for example, be fastened in an articulated manner to the receiving portion. Furthermore, the support frame can be formed elastically deformable, in order to adapt elastically to certain shapes of the cavities of the ventilation system.

The cleaning cloth consists in particular of a felt-like, fibrous or a woven material. The cleaning cloth can, for example, form a microfiber cloth, For example, the cleaning cloth can consist of an organic substance, such as, for example, cotton. Furthermore, the cleaning cloth can consist of a plastic-like fabric.

Furthermore, the device comprises a receiving portion. A cleaning agent container can be exchangeably received in the receiving portion and fastened at a predefined position. The cleaning agent container comprises, in particular, a cleaning liquid which can be dispensed, for example, in the form of a spray, aerosol or foam. The receiving portion can simultaneously form a handle of the device. The user can grip the receiving portion and, for example, handle the device such that the cleaning portion can be introduced into the cavity to be cleaned.

The receiving portion is coupled to the cleaning portion such that the cleaning agent can emerge from the cleaning agent container and can flow into the inner volume of the cleaning portion. The cleaning agent thus wets and moistens the cleaning cloth. The cleaning agent container can contain, for example, the cleaning agent at a pressure of 0.5 bar to 12 bar. The cleaning agent container furthermore comprises an outlet tube or a riser pipe with a diameter of 0.5 mm to 10 mm. Since the support frame stretches the cleaning cloth and the inner volume in the pocket-shaped cleaning cloth is thereby formed, the cleaning agent reaches the inner surfaces of the cleaning cloth over a large area, so that the cleaning cloth is soaked homogeneously and uniformly over the entire surface with the cleaning agent.

With this cleaning cloth soaked with cleaning agent, the cleaning portion can now be introduced into the cavity to be cleaned and thus both a chemical and a mechanical cleaning can be carried out simultaneously. The cleaning cloth is automatically soaked with cleaning agent, so that the cleaning agent can be applied to the surfaces to be cleaned in the cavities, At the same time, the cleaning cloth is stabilized by the support frame, so that the user can carry out a mechanical cleaning by pushing the cleaning portion together with the cleaning cloth over the surfaces. In this case, it is sufficient if only the cleaning portion and not the hand of the user is introduced into the cavity to be cleaned. A two-stage cleaning process is thus not necessary, according to which cleaning agent is applied first and subsequently a mechanical cleaning is carried out with a cleaning cloth. With the device according to the disclosure, both a chemical and a mechanical cleaning step can be carried out simultaneously, so that an efficient cleaning of cavities in a ventilation system is made possible. With the device according to the disclosure, a simple and a protection against injuries during the cleaning with the hand by sharp edges in the air filter box or the ventilation system is possible.

According to a further exemplary embodiment, the receiving portion comprises a clamping element which is configured to hold the cleaning agent container by means of a clamping fastening. For example, the cleaning agent container can comprise a tie (German: Bund) or a collar which can be introduced into the receiving portion in an insertion direction. At a predetermined holding position of the cleaning agent container, the clamping element clamps the cleaning agent container firmly, by the clamping element for example clamping the tie or the surface of the cleaning agent container. The clamping force is selected such that due to the weight force of the cleaning agent container, the latter cannot fall out of the receiving portion, but a release force must be applied by the user against the insertion direction.

The cleaning cloth can be pulled over the support frame and then the cleaning agent container can be introduced into the handle or into the receiving portion. By pressing the cleaning agent container (e.g. spray can), the cleaning agent container empties and then moistens the cleaning cloth from the inside. The cleaning agent container is designed such that the cleaning agent which is to be applied and which is under pressure flows out of the cleaning agent container uniformly and into the edge regions into the inner volume of the pocket-shaped cleaning cloth, so that the inner surfaces of the cleaning cloth are uniformly soaked with the cleaning agent over the entire surface. Accordingly, the cavities can be cleaned chemically and mechanically. Subsequently, a new pollen filter can be inserted into the clean environment.

According to a further exemplary embodiment, the clamping element comprises an elastic material. For example, the clamping element can be made of a rubber-like material, for example of hard rubber.

According to a further exemplary embodiment, a spring element is provided in the receiving portion, by means of which the clamping element can be pressed against the cleaning agent container. Alternatively or additionally to the restoring force of the clamping element due for example to the implementation with elastic material, a spring force can generate the necessary clamping force, by the spring force pressing the clamping element in the direction of the cleaning agent container.

According to a further exemplary embodiment, the receiving portion comprises a latching element which can be pressed into a recess of the cleaning agent container, for example by means of the spring element. The latching element can, for example, be arranged displaceably in the receiving portion and can be biased in the direction of the cleaning agent container by means of a spring force.

According to a further exemplary embodiment, a flow channel is formed between the receiving portion and the cleaning portion such that an outflow element of the cleaning agent container protrudes into the flow channel when the cleaning agent container is received in the receiving portion. The flow channel comprises, for example, a diameter between 0.5 mm (millimeters) and 10 mm. The cleaning agent container can, for example, comprise an outflow valve with a corresponding outlet tube. The flow channel can be arranged in the receiving portion such that, when the cleaning agent container is fastened at the predetermined location in the receiving portion, the outlet tube protrudes into the flow channel. In order to enable a simpler reception in the flow channel, the opening can be formed funnel-shaped at the opening of the flow channel into the receiving portion, so that, when the cleaning agent container is inserted into the receiving portion, the outlet tube is centered and securely received in the flow channel. A sealing element, for example a sealing ring made of rubber, can be provided in the opening of the flow channel, in order to seal the receiving tube of the cleaning agent container with the wall of the flow channel.

According to a further exemplary embodiment, the support frame comprises at least two spaced-apart support rods, which extend spaced apart from each other from the receiving portion along a longitudinal direction and are spaced apart along a transverse direction, which runs perpendicular to the longitudinal direction. The support rods are formed such that the cleaning cloth can be put over the support rods and the inner volume is formable between the support rods. The longitudinal direction defines the extension direction of the support rod from the receiving portion in the direction of the opposite free end of the support rod. The transverse direction is defined perpendicular to the longitudinal direction, wherein the distance of the support rod from one another is defined along the transverse direction. The support rods can extend parallel from the receiving portion and thus have an equal distance in the transverse direction at the receiving portion and at the respective free end. Alternatively, the support rods can likewise extend in a v-shape from the receiving portion, so that the distance in the transverse direction between the support rods is smaller at the receiving portion than at the free end thereof. Alternatively, the support rods can extend from the receiving portion such that the distance in the transverse direction between the support rods is greater at the receiving portion than at the free end thereof.

The support rods can, for example, have a round or rectangular cross-section. In particular, the support rods can have a rectangular cross-section and run in a thin-walled or band-like manner.

According to a further exemplary embodiment, the support rods comprise an upper side edge and a lower side edge along a width direction, which is formed perpendicular to the longitudinal direction and to the transverse direction. The upper side edge and the lower side edge are formed such that the put-over cleaning cloth rests on the upper side edge and the lower side edge at least in regions, in order to form the inner volume. The width direction is correspondingly formed perpendicular to the longitudinal direction and to the transverse direction and determines the width of the support rod. For example, the support rods have a rectangular cross-section, according to which the width in the width direction defines the distance between the upper side edge and the lower side edge. The thickness of a support rod is defined in the rectangular cross-section in particular along the transverse direction and the length of a support rod along the longitudinal direction. In particular, a support rod is formed in a band-like manner, i.e. with a rectangular cross-section, wherein the width is at least five times, at least ten times or in particular more than 20 times greater than the thickness.

The distance of the upper side edge and the lower side edge defines the distance between an upper surface and a lower surface of the cleaning cloth due to the support of the corresponding surfaces of the cleaning cloth. The greater the distance of the upper side edge and lower side edge, the greater the corresponding distance between an upper and a lower surface of the cleaning cloth and the correspondingly greater the inner volume is formed.

According to a further exemplary embodiment, between the upper side edges of the support rods at least one upper connecting bar is provided, on which a region of the cleaning cloth can be placed. The connecting bar thus prevents the cleaning cloth from falling between the support rods in the direction of the inner volume and thus disturbs the distribution of the cleaning agent. At the same time, the connecting bar serves for stabilizing or stiffening the support rods. The connecting bar can consist of the same material as the support rod and can be configured monolithically or integrally with the support rods.

According to a further exemplary embodiment, between the lower side edges of the support rods at least one lower connecting bar is provided, on which a region of the cleaning cloth can be placed. The lower connecting bar can be configured corresponding to the upper connecting bar. Between the upper connecting bar and the lower connecting bar there is a region of the inner volume. Since the cleaning cloth rests on the connecting bars, the upper connecting bar and the lower connecting bar prevent the cleaning cloth from folding together between the support rods and interrupting the inner volume.

Alternatively, a corresponding connecting bar can also be fastened centrally, i.e. between the upper side edge and the lower side edge of a support rod and can, for example, comprise in its course to the other support rod in the transverse direction, for example, an eye or a passage for forming the inner volume, whereby the inner volume is not interrupted in the longitudinal direction.

According to a further exemplary embodiment, the lower connecting bar and the upper connecting bar run parallel to one another between the support rods. Alternatively, the connecting bars can have an angle in the course to one another. Thus, for example, the connecting bars can comprise an angle of 30° to 60°, in particular 45°, to one another.

According to a further exemplary embodiment, the lower connecting bar and the upper connecting bar are arranged above one another in the width direction. In other words, the connecting bars overlap along a projection direction in the width direction.

According to a further exemplary embodiment, the lower connecting bar and the upper connecting bar are arranged offset from one another in the extension direction (i.e. in the longitudinal direction) of the support rods. In other words, an upper connecting bar is arranged spaced apart from an adjacent lower connecting bar in the longitudinal direction. Thus, it is ensured over the entire longitudinal direction with few connecting points that the inner volume is formed in the longitudinal direction and the risk that an upper surface of the cleaning cloth touches a lower cloth surface of the cleaning cloth and thus interrupts the inner volume is reduced.

According to a further exemplary embodiment, at least the upper connecting bar is arranged on the upper side edges of the support rods, so that a bearing region of the upper connecting bar for the cleaning cloth is spaced apart from the upper side edges in the width direction. Additionally or alternatively, at least the lower connecting bar is arranged on the lower side edges of the support rods, so that a bearing region of the lower connecting bar for the cleaning cloth is spaced apart from the lower side edges in the width direction. In other words, an upper cloth surface on the support rods touches an upper surface of the upper connecting bar and between two adjacent upper connecting bars the surface of the upper side edge of the corresponding support rod. A zigzag-shaped bearing surface for the upper cloth surface along the support rods is thus created. This correspondingly applies to the lower cloth surface along the lower side edge of the support rods. This increases, for example, the friction of the cleaning cloth on the support rod, so that an undesired detachment of the cleaning cloth from the support frame is prevented.

According to a further exemplary embodiment, the support frame comprises a stabilizing bar, which connects the free ends of the support rods. The support rods thus comprise a rigid connection at their respective ends, so that a robust embodiment is created.

According to a further exemplary embodiment of the method, the receiving portion and the cleaning portion are produced integrally by means of injection molding. Correspondingly, the receiving portion and the cleaning portion are configured integrally and in one piece.

Alternatively, the receiving portion and the cleaning portion can be produced separately from one another and connected with a detachable (for example screw connection) or firm connection (for example adhesive connection).

According to a further exemplary embodiment, the cleaning portion, in particular the support frame, is arranged in an articulated manner on the receiving portion such that the cleaning portion is adjustable relative to the receiving portion. An angle can thus be formed between the receiving portion and the cleaning portion and a simpler operation can be created precisely during the cleaning of difficult-to-access cavities. Correspondingly, a joint can be provided between the receiving portion and the cleaning portion. The joint can enable, in the manner of a hinge, the cleaning portion to be pivotable about an axis of rotation relative to the receiving portion. Furthermore, a joint with two pivot axes or more (for example a ball joint) can also be provided.

Additionally or alternatively, the cleaning portion, in particular the support frame, can comprise an elastic region such that the cleaning portion is deformable relative to the receiving portion. An angle can thus likewise be formed between the receiving portion and the cleaning portion.

According to an exemplary embodiment, at least one hook element is formed on the support frame. The hook element is configured to hook into a material or into a receiving opening of the cleaning cloth and to secure it against slipping. The hook element forms, so to speak, a projection which extends from a surface of the support frame, in particular from the support frame in the direction of the cleaning cloth. The hook element can thereby penetrate into the cleaning cloth or penetrate the latter, in order to produce, so to speak, a form-fitting connection and to secure the cleaning cloth against slipping relative to the support frame. Furthermore, the hook element can be configured to be pointed (German: spitz ausgeführt) at the free end, in order to penetrate into the cleaning cloth for hooking. Alternatively, the cleaning cloth can comprise a receiving opening, through which the hook element can reach. In this case, the free end of the hook element can also be configured to be blunt, in order to avoid injuries.

The hook element can be produced from the same material as the support frame and can, for example, be produced integrally and in one piece in a production process together with the support frame. Alternatively, the hook element can be made of a different material than the support frame and can, for example, be fastened to the support frame with an adhesive connection or a screw connection.

The hook element can be configured as a projection with a rectilinear (I-shaped) shape. Alternatively, the hook element can be configured to be curved, for example sickle-shaped or L-shaped.

In particular, a single hook element can be provided, but preferably two spaced-apart hook elements, which are each formed, for example, on opposite support rods. Furthermore, a plurality of further hook elements can also be fastened to the support frame, in order to fasten the cleaning cloth.

The hook element thus serves to hook into the cleaning cloth, so that slipping of the cleaning cloth is prevented. Due to a slight stretchability of the cleaning cloth, the latter can be slightly stretched when being put over the support frame and pulled over the hook element.

According to an exemplary embodiment, the hook element is formed on a support rod of the support frame and extends from the support rod, in particular in the direction of the receiving portion. The cleaning cloth can thus be put over the support frame from the stabilizing bar in the direction of the receiving portion. After being put over the support frame, the region of the opening of the cleaning cloth is subsequently located in a region between the receiving portion and the cleaning portion. If the hook elements now extend from the support frame in the direction of the receiving portion, the cleaning cloth can be hooked in the region of the opening of the cleaning cloth, so that slipping of the cleaning cloth relative to the support frame can be efficiently prevented.

Alternatively, the hook element can likewise be fastened to the stabilizing bar described above or to one of the upper or lower connecting bars and can extend correspondingly therefrom.

According to an exemplary embodiment, the hook element is formed such that a free end of the hook element is present between two opposite support rods. The hooking into the cleaning cloth takes place at the free end of the hook element. If a free end of the hook element according to the exemplary embodiment extends inward, i.e. in a region between two opposite support rods, a projection of the hook element outward, i.e. outside the support rod, is prevented, so that correspondingly undesired contacts between the free end of the hook element and regions of the surface to be cleaned can be prevented and correspondingly scratches or other damage in the surface to be cleaned can be avoided.

In summary, the device according to the disclosure enables the reduced accessibility of housings of cabin air filters in motor vehicles, The adapted geometry of the device achieves a higher cleaning effect in particular in the region of the corners and edges of the filter box of a ventilation system. The device combines the requirement of a chemical-mechanical cleaning component within a cleaning tool. Compared to the application of cleaning liquid to a rag or the direct introduction of the cleaning liquid into a filter box, a uniform distribution on the surface to be wetted is achieved with the use of the device according to the disclosure. Compared to the final mechanical cleaning step by means of hand and rag, a uniform removal of the contaminants from the filter box is achieved with the use of the device according to the disclosure. The device according to the disclosure can be designed such that the size of the cleaning agent container for a cleaning with the cleaning liquid is portioned and a disposable cloth use additionally ensures the hygiene result.

It is pointed out that the embodiments described here represent only a limited selection of possible embodiment variants of the disclosure. Thus, it is possible to combine the features of individual embodiments with one another in a suitable manner, so that for the person skilled in the art with the embodiment variants explicit here, a plurality of different embodiments are to be regarded as obviously disclosed. In particular, some embodiments of the disclosure are described with device claims and other embodiments of the disclosure with method claims. However, to the person skilled in the art it will immediately become clear when reading this application that, unless explicitly stated otherwise, in addition to a combination of features which belong to a type of subject matter of the disclosure, an arbitrary combination of features which belong to different types of subject matter of the disclosure is also possible.

### BRIEF DESCRIPTION OF THE DRAWINGS

In the following, for further explanation and for better understanding of the present disclosure, exemplary embodiments are described in more detail with reference to the attached drawings. In the drawings:

FIG. 1 shows a perspective view of a device for cleaning cavities according to an exemplary embodiment of the present disclosure.

FIG. 2 shows a plan view of the device of FIG. 1.

FIG. 3 shows a side view of a device for cleaning cavities with corresponding upper and lower side edges of a support rod according to an exemplary embodiment of the present disclosure.

FIG. 4 shows a perspective sectional view of a device for cleaning cavities according to an exemplary embodiment of the present disclosure.

FIG. 5 shows a perspective sectional view of a receiving portion according to an exemplary embodiment of the present disclosure.

FIG. 6 shows an exemplary view of a cleaning agent container for reception in the receiving portion.

FIG. 7 shows a schematic view of a device for cleaning cavities, in which a cleaning cloth is fastened to the cleaning portion, according to an exemplary embodiment of the present disclosure.

FIGS. 8 and 9 show schematic views of a device for cleaning cavities with hook elements for holding a cleaning cloth, according to an exemplary embodiment of the present disclosure.

### DETAILED DESCRIPTION OF EXEMPLARY EMBODIMENTS

Identical or similar components in different figures are provided with identical reference numerals. The views in the figures are schematic.

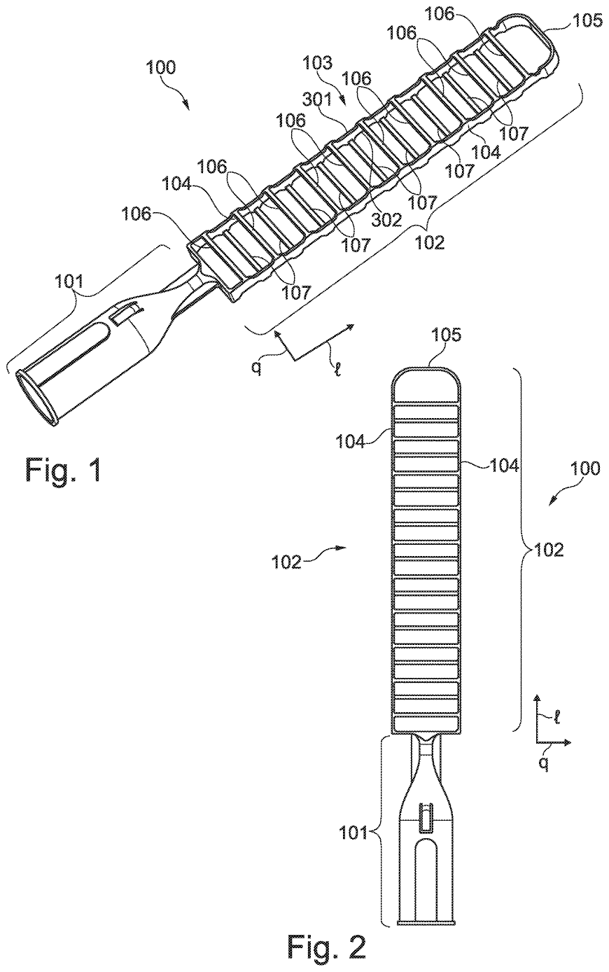

FIG. 1 shows a perspective view and FIG. 2 shows a plan view of a device 100 for cleaning cavities according to an exemplary embodiment of the present disclosure.

The present disclosure relates to a device 100 for cleaning cavities of a ventilation system, in particular of a vehicle, by means of a cleaning agent. The device 100 comprises a receiving portion 101 for receiving a cleaning agent container 600 (see FIG. 6) and a cleaning portion 102, wherein the cleaning portion 102 forms a support frame 103 which is configured such that a pocket-shaped cleaning cloth 700 (see FIG. 7) can be put over the cleaning portion 102, so that an inner volume is formable. The cleaning portion 102 is coupled to the receiving portion 101 such that a cleaning agent of the cleaning agent container 600, which can be fastened in the receiving portion 101, can flow from the receiving portion 101 into the inner volume.

A pocket-shaped cleaning cloth 700 can be put over on the support frame 103. The support frame 103 stabilizes and thus supports the cleaning cloth 700, so that the cleaning cloth 700 can be introduced together with the support frame 103, for example, into a cavity of the ventilation system, in order to carry out a mechanical cleaning.

Furthermore, the device 100 comprises a receiving portion 101. A cleaning agent container 600 can be exchangeably received in the receiving portion 101 and fastened at a predefined position. The cleaning agent container 600 comprises, in particular, a cleaning liquid which can be dispensed, for example, in the form of a spray, foam or aerosol.

The receiving portion 101 is coupled to the cleaning portion 102 such that the cleaning agent can emerge from the cleaning agent container 600 and can flow uniformly into the edge region into the inner volume of the cleaning portion 102. The cleaning agent thus wets and moistens the cleaning cloth 700 from the inside. Since the support frame 103 stretches the cleaning cloth 700 and the inner volume in the pocket-shaped cleaning cloth 700 is thereby formed, the cleaning agent reaches the inner surfaces of the cleaning cloth 700 over a large area, so that the cleaning cloth is soaked homogeneously and uniformly over the entire surface with the cleaning agent.

The support frame 103 comprises at least two spaced-apart support rods 104, which extend spaced apart from each other from the receiving portion 101 along a longitudinal direction l and are spaced apart along a transverse direction q, which runs perpendicular to the longitudinal direction l. The support rods 104 are formed such that the cleaning cloth 700 can be put over the support rods 104 and the inner volume is formable between the support rods 104. The longitudinal direction l defines the extension direction of the support rod 104 from the receiving portion 101 in the direction of the opposite free end of the support rod 104.

The support rods 104 run parallel from the receiving portion 101 and have an equal distance in the transverse direction q at the receiving portion 101 and at the respective free end.

The distance of the upper side edge 301 and the lower side edge 302 defines the distance between an upper surface and a lower surface of the cleaning cloth 700 due to the support of the corresponding surfaces of the cleaning cloth 700. The greater the distance of the upper side edge 301 and lower side edge 302, the greater the corresponding distance between an upper and a lower surface of the cleaning cloth 700 and the correspondingly greater the inner volume is formed.

Between the upper side edges 301 of the support rods 104 at least one upper connecting bar 106 is provided, on which a region of the cleaning cloth 700 can be placed. The connecting bar 106 thus prevents the cleaning cloth 700 from falling between the support rod 104 in the direction of the inner volume and thus disturbs the distribution of the cleaning agent.

Furthermore, between the lower side edges 302 of the support rods 104 at least one lower connecting bar 107 is provided, on which a region of the cleaning cloth 700 can be placed. The lower connecting bar 107 can be configured corresponding to the upper connecting bar 106. Between the upper connecting bar 106 and the lower connecting bar 107 there is a region of the inner volume. Since the cleaning cloth 700 rests on the connecting bars 106, 107, the upper connecting bar 106 and the lower connecting bar 107 prevent the cleaning cloth 700 from folding together between the support rods 104 and interrupting the inner volume. The lower connecting bar 107 and the upper connecting bar 106 run parallel to one another between the support rods 104.

As illustrated in FIG. 1, the lower connecting bar 107 and the upper connecting bar 106 are arranged offset from one another in the extension direction (i.e. in the longitudinal direction l) of the support rods 104. In other words, an upper connecting bar 106 is arranged spaced apart from an adjacent lower connecting bar 107 in the longitudinal direction l. Thus, it is ensured over the entire longitudinal direction l with few connecting points that the inner volume is formed in the longitudinal direction l and the risk is reduced that an upper surface of the cleaning cloth 700 touches a lower cloth surface of the cleaning cloth 700 and thus interrupts the inner volume.

The support frame 103 furthermore comprises a stabilizing bar 105, which connects the free ends of the support rods 104. The support rods 104 thus comprise a rigid connection at their respective ends, so that a robust embodiment is created.

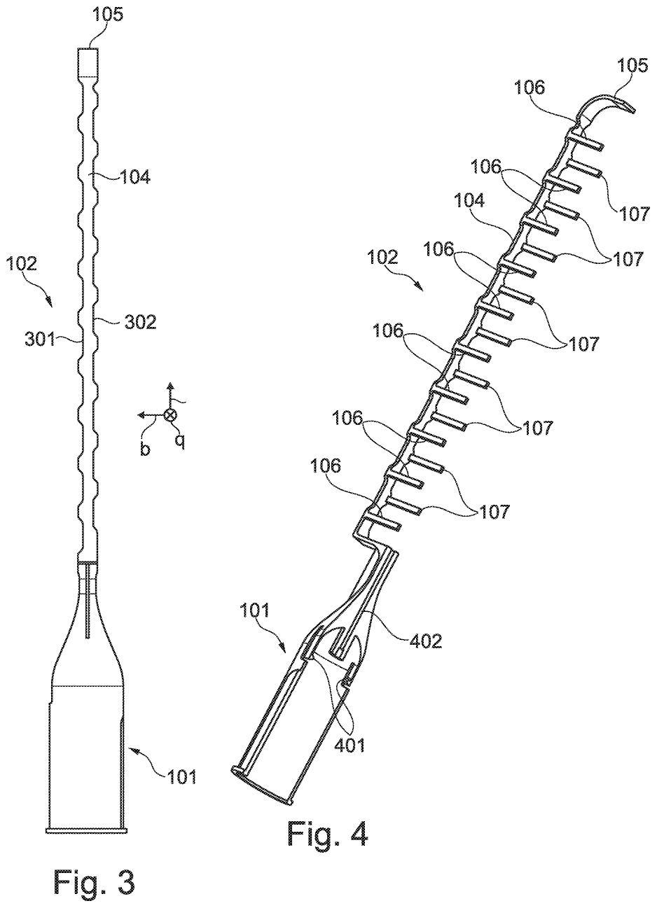

FIG. 3 shows a side view and FIG. 4 shows a perspective sectional view of a device 100 for cleaning cavities with corresponding upper and lower side edges 301, 302 of a support rod 104 according to an exemplary embodiment of the present disclosure.

The support rods 104 comprise an upper side edge 301 and a lower side edge 302 along a width direction b, which is formed perpendicular to the longitudinal direction l and to the transverse direction q. The upper side edge 301 and the lower side edge 302 are formed such that the put-over cleaning cloth 700 rests on the upper side edge 301 and the lower side edge 302 at least in regions, in order to form the inner volume.

The support rods 104 comprise a rectangular cross-section, according to which the width in the width direction b defines the distance between the upper side edge 301 and the lower side edge 302. The thickness of a support rod 104 is defined in the rectangular cross-section in particular along the transverse direction q and the length of a support rod 104 along the longitudinal direction l. In particular, a support rod 104 is formed in a band-like manner, i.e. with a rectangular cross-section, wherein the width is at least five times greater than the thickness.

The upper connecting bar 106 is arranged on the upper side edges 301 of the support rods 104, so that a bearing region of the upper connecting bar 106 for the cleaning cloth 700 is spaced apart from the upper side edges 301 in the width direction b. Additionally, at least the lower connecting bar 107 is arranged on the lower side edges 302 of the support rods 104, so that a bearing region of the lower connecting bar 107 for the cleaning cloth 700 is spaced apart from the lower side edges 302 in the width direction b. In other words, an upper cloth surface on the support rods 104 touches an upper surface of the upper connecting bar 106 and between two adjacent upper connecting bars 106 the surface of the upper side edge 301 of the corresponding support rod 104. A zigzag-shaped bearing surface for the upper cloth surface along the support rods 104 is thus created. This correspondingly applies to the lower cloth surface along the lower side edge 302 in the support rods 104.

A flow channel 402 is illustrated in the sectional view in FIG. 3. The flow channel 402 is formed between the receiving portion 101 and the cleaning portion 102 such that an outflow element 603 (see FIG. 6) of the cleaning agent container 600 protrudes into the flow channel 402 when the cleaning agent container 600 is received in the receiving portion 101. The cleaning agent container 600 is fixed in the receiving portion 101 for example by means of a clamping element 401. The cleaning agent can thus escape from the outflow element 603, flow through the flow channel 402 between the receiving portion 101 and the cleaning portion 102 and in particular through the inner volume as far as the free end of the support rod 104 or the stabilizing bar 105.

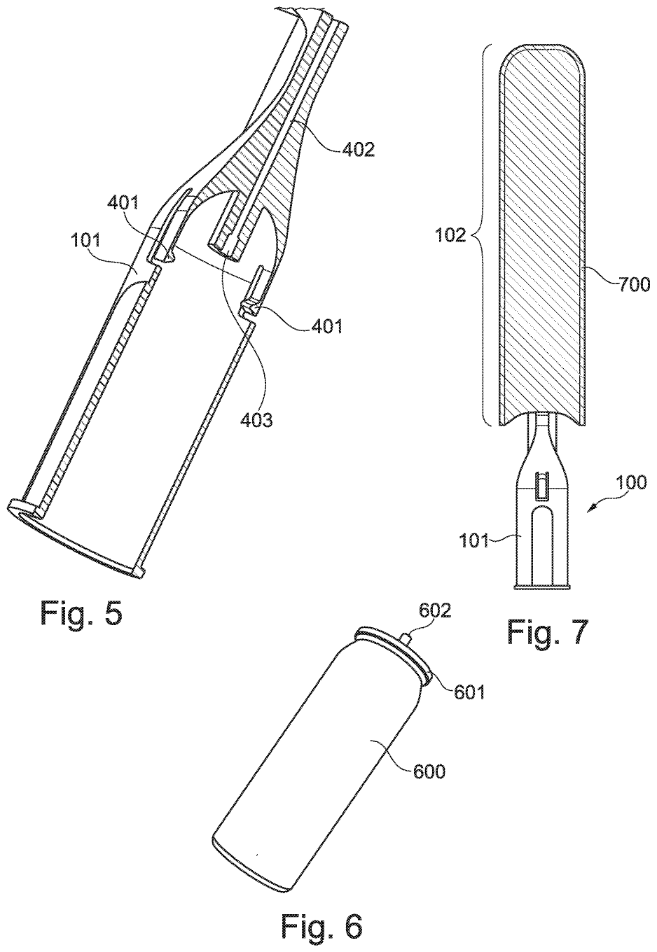

FIG. 5 shows a perspective sectional view of a receiving portion 101 according to an exemplary embodiment of the present disclosure.

The receiving portion 101 comprises a clamping element 401 which is configured to hold the cleaning agent container 600 by means of a clamping fastening. The clamping element 401 is configured to be elastic, for example. The clamping element 401 can be configured for example as an elastic lug (German: Lasche) in the housing of the receiving portion 101. As illustrated in FIG. 5, two clamping elements 401 can be configured as a lug and can be configured opposite one another in the receiving portion 101. The user can correspondingly grip around the receiving portion 101 and press the clamping elements 401 together. At a free end, the clamping elements 401 comprise for example a clamping wedge, which can apply a high pressing force to an inner cleaning agent container 600. As illustrated in FIG. 6, the clamping wedges can engage on a tie 601 of the cleaning agent container 600 in order to improve the fixing.

The cleaning agent container 600 can, for example, comprise an outflow valve with a corresponding outlet tube (outlet element 602). The flow channel 402 in the receiving portion 101 can be arranged such that, when the cleaning agent container 600 is fastened at the predetermined location in the receiving portion 101, the outlet tube protrudes into the flow channel 402. In order to enable a simpler reception in the flow channel 402, the opening can be formed funnel-shaped or step-like at the opening of the flow channel 402 into the receiving portion 101, so that, when the cleaning agent container 600 is inserted into the receiving portion 101, the outlet tube is centered and securely received in the flow channel 402. A sealing element, for example a sealing ring made of rubber, can be provided in the opening of the flow channel 402, in order to seal the receiving tube of the cleaning agent container 600 with the wall of the flow channel 402.

FIG. 6 shows an exemplary illustration of a cleaning agent container 600, for example a spray can, for reception in the receiving portion 101.

The cleaning agent container 600 can, for example, contain the cleaning agent at a pressure of 0.5 bar to 12 bar. For example, the cleaning agent container 600 can comprise a tie 601 or a collar which can be introduced into the receiving portion 101 in an insertion direction. At a predetermined holding position of the cleaning agent container 600, the clamping element 401 clamps the cleaning agent container 600 firmly, by the clamping element 401 for example clamping the tie 601 or the surface of the cleaning agent container 600. The clamping force is selected such that due to the weight force of the cleaning agent container 600, the latter cannot fall out of the receiving portion 101, but a release force must be applied by the user against the insertion direction.

FIG. 7 shows a schematic view of a device 100 for cleaning cavities, in which a cleaning cloth 700 is fastened to the cleaning portion 102, according to an exemplary embodiment of the present disclosure.

In particular, the support frame 103 is formed such that a pocket-shaped cleaning cloth 700 can be stretched, so that an interior volume (inner volume) can be formed. For example, the support frame 103 spaces apart an opposite front and rear surface-shaped cleaning portion 102 of the cleaning cloth 700. The width of the support frame 103 in the width direction b, by which the cleaning cloth 700 is stretched (German: aufgespannt), is in particular less than 2 cm, in particular less than 1 cm, so that the support frame 103 together with the cleaning cloth 700 itself can be introduced into small openings of a filter box, through which the hand of a user would not fit.

With this cleaning cloth 700 soaked with cleaning agent, the cleaning portion 102 can now be introduced into the cavity to be cleaned and thus both a chemical and a mechanical cleaning can be carried out simultaneously. The cleaning cloth 700 is automatically soaked with cleaning agent, by the cleaning agent container 600 dispensing the cleaning agent into the inner volume and the cleaning agent is distributed over the entire inner volume.

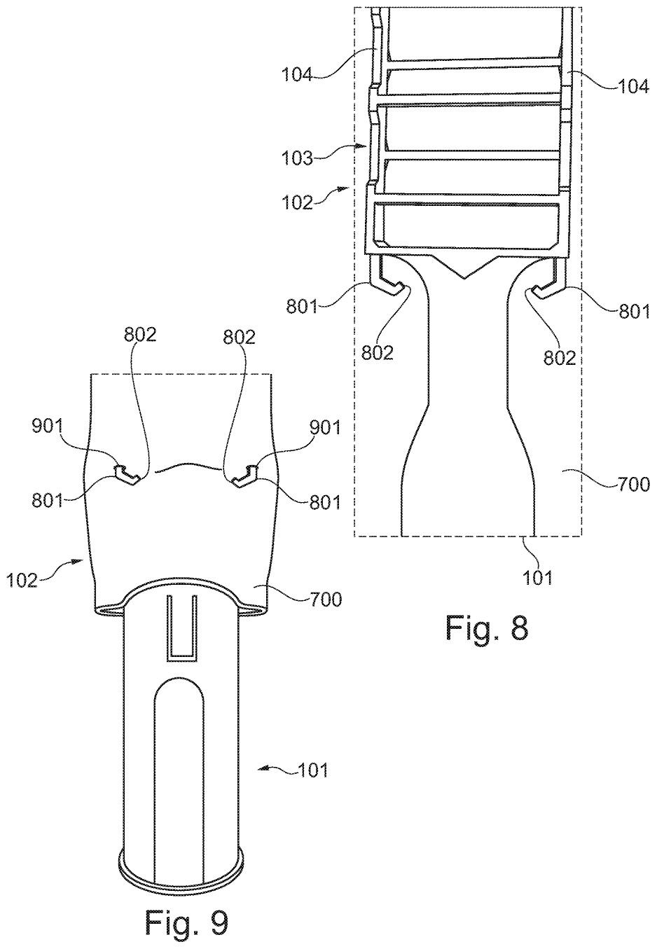

FIGS. 8 and 9 show an exemplary embodiment of the cleaning device 100 with hook elements 801 for holding a cleaning cloth 700, according to an exemplary embodiment of the present disclosure. Two hook elements 801 are formed on the support frame 103. These are configured to hook into a material or into a receiving opening 901 of the cleaning cloth 700 and to secure it against slipping. The hook elements 801 form projections which extend from a surface of the support frame 103, in particular in the direction of the receiving portion 101 from the lower ends of the support rods 104. The hook elements 801 can thereby penetrate into the cleaning cloth 700 or penetrate the latter, in order to produce, so to speak, a form-fitting connection and to secure the cleaning cloth 700 against slipping relative to the support frame 103.

In FIG. 9, the cleaning cloth 700 comprises a receiving opening 901, through which the free ends 802 of the hook elements 801 can grasp.

The hook elements 801 can be produced from the same material as the support frame 103 and can, for example, be produced integrally and in one piece in a production process together with the support frame 103.

In the illustrated embodiment, the hook elements 801 comprise a sickle-shaped structure. If the free ends 802 are inserted through a receiving opening 901 of the cleaning cloth 700, the risk that the cleaning cloth 700 is unintentionally detached from the hook elements 801 is reduced due to the sickle shape.

The cleaning cloth 700 is put over the support frame 103 from the stabilizing bar 105 in the direction of the receiving portion 101. After being put over the support frame 103, the region of the opening of the cleaning cloth 700 is subsequently located in a region between the receiving portion 101 and the cleaning portion 102 (see FIG. 9). If the hook elements 801 now extend from the support frame 103 in the direction of the receiving portion 101, the cleaning cloth 700 can be hooked in the region of the opening of the cleaning cloth 700, so that slipping of the cleaning cloth 700 relative to the support frame 103 can be efficiently prevented.

In particular, the free ends 802 of the hook elements 801 are located between two opposite support rods 104. The hooking into the cleaning cloth 700 takes place at the free ends 802 of the hook elements 801. If a free end 802 of the hook element 801 extends inward, a projection of the corresponding hook element 801 outward, i.e. outside the support rods 104, is prevented, so that correspondingly undesired contacts between the free ends 802 of the hook elements 801 and regions of the surface to be cleaned are prevented.

In addition, it should be noted that “comprising” does not exclude any other elements or steps and “a” or “an” does not exclude a plurality. Furthermore, it should be pointed out that features or steps which have been described with reference to one of the above exemplary embodiments can also be used in combination with other features or steps of other exemplary embodiments described above. Reference signs in the claims are not to be regarded as a restriction.

### LIST OF REFERENCE SIGNS

100 Device
101 Receiving portion
102 Cleaning portion
103 Support frame
104 Support rod
105 Stabilizing bar
106 Upper connecting bar
107 Lower connecting bar
301 Upper side edge
302 Lower side edge
401 Clamping element
402 Flow channel
403 Funnel-shaped reception
600 Cleaning agent container
601 Tie
602 Outflow element
700 Cleaning cloth
801 Hook element
802 Free end
901 Receiving opening
l Longitudinal direction
q Transverse direction
b Width direction

1.-23. (canceled)

24. A device for cleaning cavities of a ventilation system by means of a cleaning agent, the device comprising
a receiving portion for receiving a cleaning agent container,
a cleaning portion,
wherein the cleaning portion forms a support frame which is configured such that a pocket-shaped cleaning cloth can be put over the cleaning portion, so that an inner volume is formable,
wherein the cleaning portion is coupled to the receiving portion such that a cleaning agent of the cleaning agent container, which can be fastened in the receiving portion, can flow from the receiving portion into the inner volume.

25. The device according to claim 24,
wherein the receiving portion comprises a clamping element which is configured to hold the cleaning agent container by means of a clamping fastening.

26. The device according to claim 25,
wherein the clamping element comprises an elastic material.

27. The device according to claim 25,
wherein the clamping element is configured by a spring element, by means of which the clamping element can be pressed against the cleaning agent container.

28. The device according to claim 24, comprising at least one of the following features:
wherein the receiving portion comprises a latching element which can be pressed into a recess of the cleaning agent container;
wherein a flow channel is formed between the receiving portion and the cleaning portion such that an outflow element of the cleaning agent container protrudes into the flow channel when the cleaning agent container is received in the receiving portion;
wherein the cleaning portion is arranged in an articulated manner on the receiving portion such that the cleaning portion is adjustable relative to the receiving portion;
wherein the cleaning portion comprises an elastic region such that the cleaning portion is deformable relative to the receiving portion.

29. The device according to claim 24,
wherein the support frame comprises at least two spaced-apart support rods, which extend spaced apart from each other from the receiving portion along a longitudinal direction, l, and are spaced apart along a transverse direction, q, which runs perpendicular to the longitudinal direction, l,
wherein the support rods are formed such that the cleaning cloth can be put over the support rods and the inner volume is formable between the support rods.

30. The device according to claim 29,
wherein the support rods comprise an upper side edge and a lower side edge along a width direction, b, which is formed perpendicular to the longitudinal direction, l, and to the transverse direction, q,
wherein the upper side edge and the lower side edge are formed such that the put-over cleaning cloth rests on the upper side edge and the lower side edge at least in regions, in order to form the inner volume.

31. The device according to claim 30,
wherein between the upper side edges of the support rods at least one upper connecting bar is provided, on which a region of the cleaning cloth can be placed.

32. The device according to claim 30,
wherein between the lower side edges of the support rods at least one lower connecting bar is provided, on which a region of the cleaning cloth can be placed.

33. The device according to claim 31,
wherein the lower connecting bar and the upper connecting bar run parallel to one another between the support rods.

34. The device according to claim 31,
wherein the lower connecting bar and the upper connecting bar are arranged above one another in the width direction, b.

35. The device according to claim 31,
wherein the lower connecting bar and the upper connecting bar are arranged offset from one another in the extension direction of the support rods.

36. The device according to claim 31,
comprising at least one of
wherein at least the upper connecting bar is arranged on the upper side edges of the support rods, so that a bearing region of the upper connecting bar for the cleaning cloth is spaced apart from the upper side edges in the width direction, b, and
wherein at least the lower connecting bar is arranged on the lower side edges of the support rods, so that a bearing region of the lower connecting bar for the cleaning cloth is spaced apart from the lower side edges in the width direction, b.

37. The device according to claim 29,
wherein the support frame comprises a stabilizing bar, which connects the free ends of the support rods.

38. The device according to claim 24,
wherein the receiving portion and the cleaning portion are configured integrally.

39. The device according to claim 24,
wherein at least one hook element is formed on the support frame,
wherein the hook element is configured to hook into a material or into a receiving opening of the cleaning cloth and to secure it against slipping.

40. The device according to claim 39,
wherein the hook element is formed on a support rod of the support frame and extends from the support rod.

41. The device according to claim 39,
wherein the hook element is formed such that a free end of the hook element is present between two opposite support rods.

42. A method for manufacturing a device for cleaning cavities of a ventilation system by means of a cleaning agent, the method comprising
providing a receiving portion for receiving a cleaning agent container,
providing a cleaning portion,
wherein the cleaning portion forms a support frame which is configured such that a pocket-shaped cleaning cloth can be put over the cleaning portion, so that an inner volume is formable, and
coupling the cleaning portion to the receiving portion such that a cleaning agent of the cleaning agent container, which can be fastened in the receiving portion, can flow from the receiving portion into the inner volume.

43. The method according to claim 42,
wherein the receiving portion and the cleaning portion are produced integrally by means of injection molding.
